(19) United States
(12) Patent Application Publication
(10) Pub. No.: US 2024/0255680 A1
(43) Pub. Date: Aug. 1, 2024

(54) DISPLAY SCREEN COVERS

(71) Applicant: Eyesafe Inc., Eden Prairie, MN (US)

(72) Inventors: Davin Saderholm, Eden Prairie, MN (US); Madelane Tveit, Saint Paul, MN (US); Christian Peterson, Eden Prairie, MN (US)

(21) Appl. No.: 18/564,725

(22) PCT Filed: Jun. 2, 2022
(86) PCT No.: PCT/US22/31930

§ 371 Date: Nov. 28, 2023

Related U.S. Application Data
(60) Provisional application No. 63/196,673, filed on Jun. 3, 2021.

(51) Int. Cl. G02B 5/20

(52) U.S. Cl. CPC G02B 5/20

(57) ABSTRACT

A display system for use with electronic display devices comprising an electronic display device, and a backlight unit. The backlight unit comprises a light-emitting array, a reflector adjacent to the light-emitting array, and a diffuser opposite the reflector. The diffuser comprises a polymer substrate, an absorbing phosphor combined with the polymer substrate, wherein the absorbing phosphor absorbs blue light, from the light-emitting array, in a blue notch band. The absorbing phosphor has a maximum absorbance peak between about 400 nm and about 530 nm, and wherein the absorbing phosphor re-emits the absorbed blue light between 495 nm and 675 nm.

### FIELD OF THE TECHNOLOGY

The disclosed invention relates to an absorbing compound or compounds that can be combined with one or more polymer substrates to be placed on or incorporated into an electronic device, including on the display screen of an electronic device.

### BACKGROUND

Handheld electronic devices, including but not limited to tablets, AR/VR/XR devices, computers, smartphones, and other device displays have trended toward higher resolutions and truer color balance that may emit undesired light in certain wavelengths. While a variety of methods can be used to achieve resolution and color, many high-performance displays include LEDs that can result in high levels of blue within the output spectrum. Many of these devices are battery powered, and users typically desire long battery life. Longer battery life generally calls for low power consumption, as well as various means for light conservation. Frequently these displays generally have not prioritized eye safety as a design goal. A growing body of medical research is developing that indicates a “toxic” blue portion of the color spectrum can have adverse effects on the eye such that in the longer term, vision impairment can result. In addition, a new body of knowledge is showing that adverse effects can occur on the natural circadian rhythm of individuals from certain portions of the optical spectrum. The present disclosure describes materials and incorporation of these materials in a mobile, tablet or PC display that are highly selective in their ability to reduce exposure to harmful blue and UV light. These materials can be optimized as a function of wavelength to maintain color white point. Many of these materials reduce total light transmission and may affect some of the color spectrum. In light of recent medical findings, increasingly ubiquitous displays, and consumer demand for high quality in displays, systems of the present disclosure solve multiple needs in a unique way.

### SUMMARY

By adding compounds to the display material, light transmission may be optimized, so that wavelengths may be absorbed into the material. Coatings may also incorporate phosphors and other materials to also absorb harmful or unwanted light, and phosphors with other materials may help with reemission of light to improve the color quality. Compounds may be added to make colors in other wavelengths sharper as well.

At least one of a shield, protective film, and protective coating layer for a device may be provided. In one embodiment, the shield for a device comprises a polymer substrate. The shield may comprise an absorbing agent dispersed within the polymer substrate. The shield may also reduce a transmissivity of an ultraviolet range of light by at least 90%, wherein the ultraviolet range of light comprises a range between 380 and 400 nanometers, and wherein a shield may reduce a transmissivity of a high energy visible light range by at least 10%, wherein the high energy visible light range comprises a range between 415 and 555 nanometers, and wherein the shield also reduces a transmissivity of a red light range by at least 10%, wherein the red light range comprises a wavelength range between 625 and 740 nanometers. These are not exact ranges or intensity reduction amounts. There is a margin of error that would change the values.

Absorption, in some instances, may occur between 400-525 nm wavelength range. Dye may be a broader absorber or may cause the material to be a broader absorber. In one embodiment, the excitation of light may occur between 400-470 nm and the normalized absorption coefficient is around 1. In some embodiments, light may transmit in a different or overlapping range, when other compounds are added. As one none limiting example, “YAG” phosphors may be used, such as Ce Phosphor. YAG may be made of fine particle of Yttrium Aluminum Garnet. When incorporated into devices, such as LEDs, materials such as YAG doped with other elements, such and Cerium or others that may have beneficial photoluminescent properties (YAG:Ce), then the resulting combination may convert blue light to white or yellow, so the emitted light may appear slightly different with the absorbed blue light. With such use, the emission occurs over a range 500-750 nm, with a margin of error of +/−20 nm. One challenge is loss of definition and color after a color filter is applied. However, definition may improve by adding phosphor(s), but it is not perfect and challenging. Phosphors may add luminance around 500-630 nm, but this depends on the display. The absorption may then be scaled back at 590-610 nm, and phosphors and dye may be added, intensifying separate green and red wavelength intensities that may provide more saturated color and a wider wavelength range of color depth.

Phosphor may be added in to absorb blue light, reducing harmful light. In some embodiments, the color may dull as a result of adding compounds, so to improve the light quality and increase the intensity of the wavelength in certain ranges, dye may be added to increase intensity. In one embodiment, green dye may be added to increase the intensity of green light emitted from the device. In other embodiments, red dye may be added separately or in addition to the other dye to increase the color red emitted, increasing the intensity of the red related colors and wavelengths within a red associated wavelength range. In some embodiments, the absorption at 575-595 nm may be preferred based on trying to adjust absorption in the green-red gap, but the absorption within this range may result in an adjusted 20 nm in a positive or negative changed value. The dye may be adapted or mixed in those wavelengths.

The ranges may have a margin or change or error +/−20 nm to the range value. Additionally, the shield may also be configured to transmit sufficient light generated by the device such that an image generated by the device is substantially unaltered by the shield. Dyes and phosphors may be added, in addition to other possible materials, to not only absorb certain wavelengths, but also to emit sharper colors detectable by the eye. These and various other features and advantages that characterize the claimed embodiments will become apparent upon reading the following detailed description and upon reviewing the associated drawings.

### BRIEF DESCRIPTION OF THE DRAWINGS

FIG. 1 depicts a graph of intensity levels of different light wavelengths.

FIG. 2 depicts a graph of normalized intensity levels of different light wavelengths.

FIG. 3 depicts a graph of sRGB wavelengths, with an indicted area of perceived color.

FIG. 4 depicts a graph of a normalized absorption coefficient over a wavelength range.

FIG. 5 is an embodiment of an illustration of a diffusion film that may include a coating.

FIG. 6 is an embodiment of an illustration of a diffusion film.

### DETAILED DESCRIPTION

Generally, the present invention relates to an absorbing compound or compounds that can be combined with one or more polymer substrates to be placed on or incorporated into an electronic device. The absorbing compound is, ideally, blue-based and provides protection to an individual from the potentially harmful light emitted by the electronic device, and the polymer substrates are used for application to or in the electronic device. The absorbing compound and polymer substrate combinations described herein can include material for making optical filters with defined transmission and optical density characteristics for visible wavelength transmissivity. The material to make such filters, in some embodiments, can include an organic dye impregnated polycarbonate composition. In application, the protective film can be applied to a device's screen surface after purchase of the electronic device or the protective film can be incorporated into the screen during production. In a further embodiment, the absorbing compound can be applied as a protective coating layer to an existing film layer or other substrate in a device screen.

### Absorbance and Absorbing Materials

Absorbance of wavelengths of light occurs as light encounters a compound. Rays of light from a light source are associated with varying wavelengths, where each wavelength is associated with a different energy. When the light strikes the compound, energy from the light may promote an electron within that compound to an anti-bonding orbital. This excitation occurs, primarily, when the energy associated with a particular wavelength of light is sufficient to excite the electron and, thus, absorb the energy. Therefore, different compounds, with electrons in different configurations, absorb different wavelengths of light. In general, the larger the amount of energy required to excite an electron, the lower the wavelength of light required. Further, a single compound may absorb multiple wavelength ranges of light from a light source as a single compound may have electrons present in a variety of configurations.

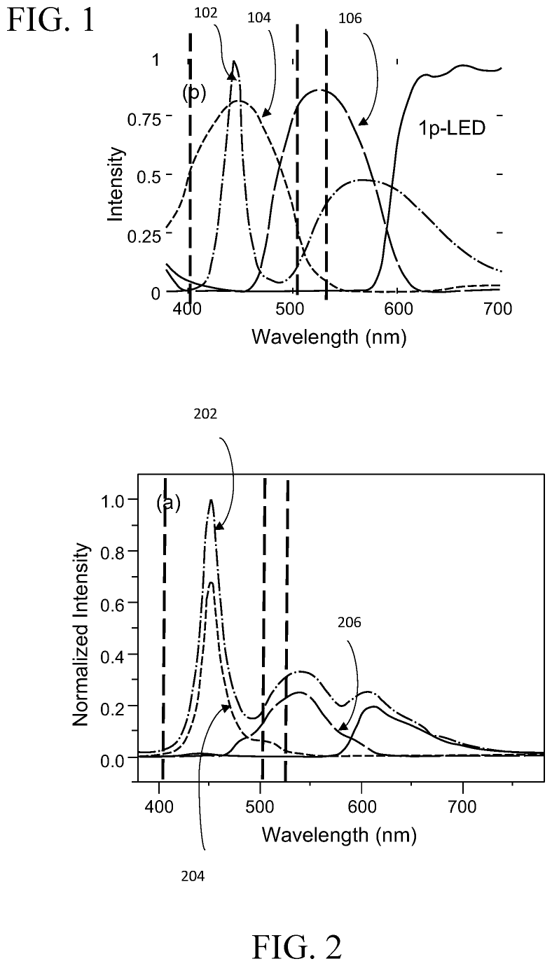

FIG. 1 is one non-limiting embodiment that is a graphical representation of an absorption curve. In this embodiment, blue light may be absorbed within the range as depicted, but using dye may create a broader range of absorption of 400-525 nm, or wider (see, e.g., wider curve 104 of FIG. 1). FIG. 1 shows pulling out blue light and measured intensity. FIG. 2 shows bigger valleys or gaps or separation between the peaks. The black line is the overall spectrum that can be defined by color filter and normalized intensity peaks with added phosphors and dyes.

By adding phosphors, intensity at different wavelength ranges can be reduced. In one embodiment, the excitation occurs between 400-470 nm (narrow curve line 102 of FIG. 1) and the normalized absorption coefficient is around 1 (see, e.g. narrow line 202 of FIG. 2). Additional elements may be added to further control the resulting light, such as the addition of a YAG phosphor, that may be doped with Ce. With the additional YAG:Ce or other combination, the absorption can be broader and may, in some embodiments and depending on the formula used, have an emission that may occur over a range 500-750 nm. There may be a margin of error for this range of +/−20 nm, and may be altered depending on the display and materials used, as well as the display lighting that is used in the device.

In one embodiment, a display device may produce a plurality of wavelengths of light including, high intensity UV light, blue violet light, blue turquoise light and visible light. High intensity UV light may comprise, in one embodiment, wavelengths of light in the 315-380 nm range. Light in this wavelength range is known to possibly cause damage to the lens of an eye. In one embodiment, blue-violet light may comprise wavelengths of light in the 380-430 nm range, and is known to potentially cause age-related macular degeneration. Blue-turquoise light may comprise light in the 430-500 nm range and is known to affect the sleep cycle and memory. Visible light may also comprise other wavelengths of light in the visible light spectrum.

As used herein, “visible light” or “visible wavelengths” refers to a wavelength range between 380 to 750 nm. “Red light” or “red wavelengths” refers to a wavelength range between about 620 to 675 nm. “Orange light” or “orange wavelengths” refers to a wavelength range between about 590 to 620 nm. “Yellow light” or “yellow wavelengths” refers to a wavelength range between about 570 to 590 nm. “Green light” or “green wavelengths” refers to a wavelength range between about 495 to 570 nm. “Blue light” or “blue wavelengths” refers to a wavelength range between about 450 to 495 nm. “Violet light” or “violet wavelengths” refers to a wavelength range between about 380 to 450 nm. As used herein, “ultraviolet” or “UV” refers to a wavelength range that includes wavelengths below 350 nm, and as low as 10 nm. “Infrared” or “IR” refers to a wavelength range that includes wavelengths above 750 nm, and as high as 3,000 nm.

FIG. 1 illustrates using phosphors to target the blue range in the light spectrum of the blue, green and red emission curves. When these curves are added together, they can become trimodal based on each color having a respective associated range of wavelengths with blue and then green and red curves. Phosphor absorption may occur near or within the blue light range peak, and thus, the blue light range peak representing blue light may be reduced. As such, an overall reduction of a blue light toxicity factor may occur.

Because the emission is broad, a definition reduction in the ranges of green and red light may occur when certain wavelengths are filtered using phosphors. To counter the reduction, dye can be added to improve effected areas or wavelengths by increasing the color intensity which sharpens the light visible to the human eye. Other dyes and elements may also be added to the light to provide even further enhanced lighting and intensity. In one embodiment, the excitation occurs between 400-470 nm with a narrow notch peak (for example, having a full width half maximum of no more than 50 nm, no more than 40 nm, no more than 30 nm, or less than 25 nm) between 400 nm and 500 nm (curve 102 of FIG. 1). In FIG. 1, luminance may be added in the range of between 500 nm and 630 nm, depending on the display. In some instances, the filtering can be pulled back between 590 nm and 600 nm, because separate green and red dyes or phosphors may provide more saturated color and wider color depth. Different combinations can achieve different results or affect the resulting light from the display. Blue phosphors may reduce blue light and color correction may occur from adding at least one of blue dye, red dye, green dye, all color dyes, and any combination thereof. In some embodiments, adding a specific color of dye can increase the intensity of the color light respective of the dye added. The dye may provide better separation of the wavelengths and may increase color intensity. In some embodiments, the additional of certain dyes and/or phosphors may cause the bleeding between colors to decrease and, therefore, the space between peaks to increase.

When a particular wavelength of light is absorbed by a compound, the color corresponding to that particular wavelength may not reach the human eye and, thus, may not be seen. Therefore, for example, in order to filter out UV light from a light source, a compound may be introduced into a film that absorbs light with a wavelength below 350 nm. The absorbing materials used in the disclosed invention can achieve protection for the individual while simultaneously leaving the color imagery of the device intact. Therefore, the absorbing compounds ideally block only a portion of the wavelength range for each color so that each hue is still visible to the individual viewing the screen of the electronic device. Further, the wavelength ranges that are blocked can be wavelength ranges for a color that are not visible to a person. Therefore, in some embodiments, the disclosed invention is a neutral density filter allowing for full color recognition.

Absorbing compounds can be selected in combination, provided that high transmission of light is maintained and the color tint is maintained, such that color integrity produced by a device remains true. In one embodiment, the absorbing compounds can be provided in a polymer or pellet form and coextruded with the polymer substrate to produce the film. In another embodiment, the absorbing compound(s) can be provided in a separate layer from the polymer substrate, for example as a component in a coating layer applied to the polymer substrate, or an additional scratch resistance layer.

In some embodiments, an absorbing phosphor can be combined with the polymer substrate. The absorbing phosphor can absorb blue light from the light-emitting array in a blue notch band, the absorbing phosphor can have a maximum absorbance peak between about 400 nm and about 530 nm (curve 104), and the absorbing phosphor can re-emit the absorbed blue light between 495 nm and 675 nm (curve 106), as shown in FIG. 1.

In the embodiment of FIG. 2, the dotted lines may indicate the reduction of light reaching the user compared to light emitted by the backlight unit as well as separation between the green and the red wavelengths (see, e.g. curve line 204) with measured normalized intensity. FIG. 2 may illustrate the intensities of specific wavelengths and the separation of peaks before and after adding dye. For example, the wavelength range between 400 nm and 525 nm (i.e., the blue light range) can be reduced by up to 23% (and up to 525 nm) with a maximum average reduction of 32-34% between 415 nm and 455 nm and can have reduced normalized intensity (see, e.g., curves 202 and 204 respectively). Due to the blue light reduction, color balancing may need to take place. Therefore, in some embodiments, color balancing ingredients, such as dyes, can be added that decrease transmission of light in the wavelength range between about 550 nm and about 620 nm by up to 11% with a maximum average emission reduction of 16-18% at 575-605 nm (see, e.g., curve 206). In some embodiments, color balancing ingredients, such as dyes, can be added that decrease transmission in the wavelength range between 640 nm and 740 nm by up to 11% with a maximum average reduction of 16-18% between 685 nm and 695 nm, and an increase in luminance of up to 10%.

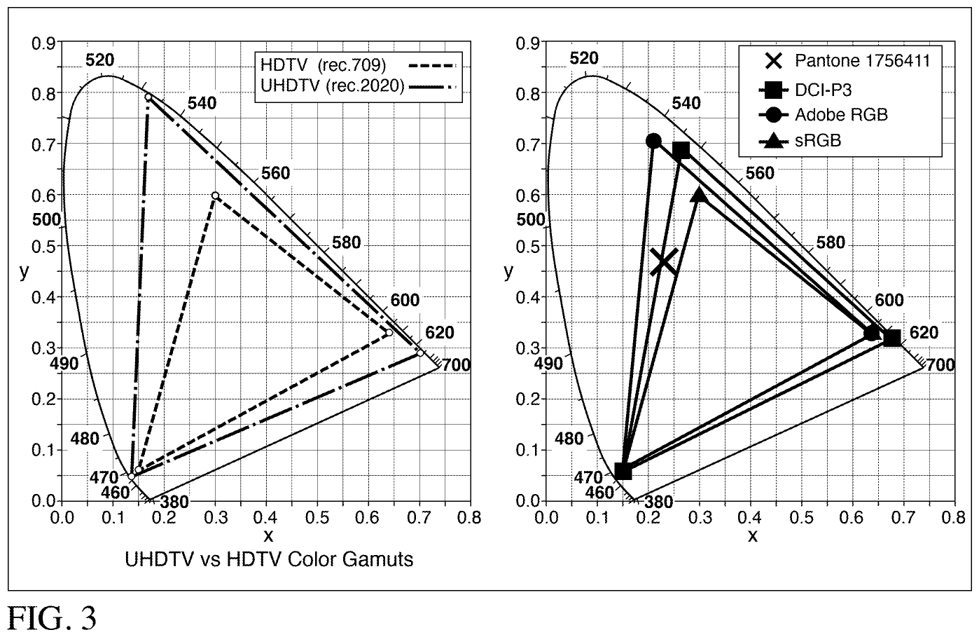

In addition to FIG. 2, color gamut shift or reduction may occur, as illustrated in FIG. 3, which illustrates the color and wavelength transmissions. FIG. 3 may illustrate the color gamut of the system with and without phosphor and/or dye as indicated by the respectively marked lines. The color gamut of FIG. 3 shows the emission of light in the resulting colors as marked, indicating the emitted light. After phosphors and corrective dyes are applied to the system, the resulting colors emitted are identified in the second color gamut and the areas of emission has been modified, as a result of the phosphors and dyes used. Color filters applied to the system that use the phosphor and dye application as described herein may also have a resulting impact.

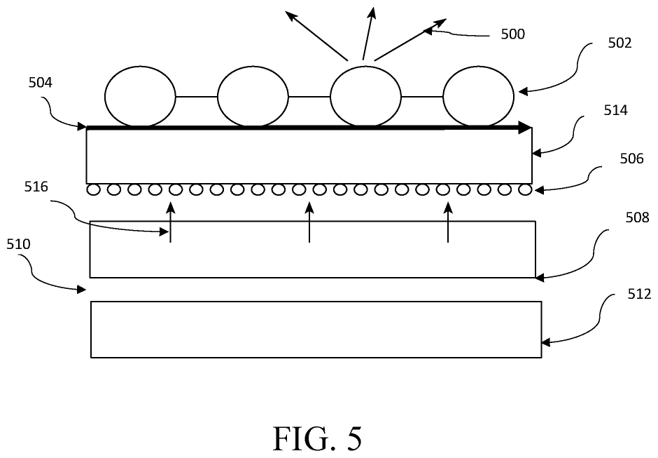

The absorbance and re-emittance can be accomplished with predetermined material and layers in the backlight unit. FIG. 5 illustrates the different layers of a filter in an electronic display that light waves can travel through, wherein the light waves exit the electronic display as filtered light 500. In some embodiments, the phosphors can be added to a portion of a diffusing layer of a backlight unit, as illustrated in FIG. 5. In some embodiments, the diffusing layer may be comprised of diffuser particles 502 embedded in a coating 504, which can be located on a PET layer 514. PET is a polymer consisting of ethylene glycol and terephthalic acid (polyethylene terephthalate) and the PET layer 514 may be sandwiched between the coating 504 and an anti-blocking layer 506. The PET layer 514 may be a layer having at least one dye and/or phosphor either dispersed throughout the layer or, as illustrated in FIG. 5, having particles at least one dye and/or phosphor in the anti-blocking layer 506 on a side of the PET layer that is opposite the coating 504. The light waves may go through PET layer 514 to diffuser particles 502, with coating 504 being present therebetween. As mentioned above, one side of PET layer 514 may be adjacent to anti-blocking layer 506. In some instances, anti-blocking layer 506 may be located next to a gap or space that is air or another transmitting material. The coating may also be used on other layers. In some embodiments, a diffuser may be made up of 3 layers. The layers can include, but are not limited to, a PET film (also known as common “plastic extruded” film) 514, a diffuser side 502 on PET film 514 (coating with large particles that scatter light), and a thin coating that is an anti-blocking layer 506 (possible on the other side). The anti-blocking layer 506 may also have particles in it that are there to keep it separate from the rest of the different layers in stack. There may be an air gap between all layers in order to act as a diffuser (prevent fusing with other layers). The portion of the backlight unit illustrated in FIG. 5 may also include a light-guide plate 508 and a reflector 512. In some embodiments, there may be a space 510 between the light-guide plate 508 and the reflector 512. Therefore, light 516 emitted by the light-guide plate 508 may be reflected by the reflector 512 towards the diffuser, wherein the light may be altered by phosphor(s) and/or dye(s) in or on the anti-blocking layer 506, the PET layer 514, and/or the diffusing layer 502, resulting in filtered light 500.

The light of the system may originate from a display system for use with electronic display devices. The electronic display device may have a backlight unit. In some embodiments, the backlight unit may include a light-emitting array, a reflector adjacent to the light-emitting array, and a diffuser opposite the reflector, wherein the diffuser comprises a polymer substrate.

Display technology may have dyes in anti-blocking layer 506, or a separate layer. Phosphors can be heavier particles and may struggle to stay suspended in acrylic coating solution, so adding silica in a coating with the phosphor(s) can improve phosphor particle suspension, such as coating layer 504. The combination with phosphors can improve the luminance of visible light. The absorbing phosphor can be at least one of Yttrium Aluminum Garnet (YAG), Beta-SiAION, oxynitrides, and K2SiF6. Additionally, diffusing layer 502 may include more of these light absorbing materials. Further, diffusing layer 502 may further comprise fumed silica, which can suspend the absorbing phosphors. Diffusing layer 502 of FIG. 5 may in some instances be structured and configured to reduce emission of blue light.

In some embodiments, a LED die may emit light in blue, and encapsulants may be used to cover a chip or electronics and limit moisture exposure. The layers that can include phosphors (e.g., any of the layers in the diffuser such as the anti-blocking layer 506, the PET layer 514, and/or the diffusing layer 502 of FIG. 5) may incorporate green and red phosphors into the layer. In one embodiment, blue photons may be converted into green and red photons. A phosphor may coat or go into an anti-blocking layer, so that the phosphor can absorb blue and reemit at other wavelengths. Luminance may improve with potential selective filtering when green/red bleeding is reduced. Adding specific quantities and combinations of compounds, at different and concentrations, of phosphors and dyes may affect the absorption and luminance of the visible light seen from each display. The absorbing compound may be a first of more than one compound, comprising an organic dye dispersed therein. The organic dye can be comprised of a blue or blue-green dye such as, but not limited to, a blue-green phthalocyanine dye. The organic dye may be comprised of a green dye or red dye.

In an embodiment where there is a second compound for absorbing light, the second compound may be the phosphor. Adding the second compound may absorb light in the blue light wavelength range, as discussed herein. In other embodiments, the second compound can absorb green or red light in the respective wavelength range as discussed herein. In some embodiments, the second compound has peak absorption between 570 nm and 600 nm. In some embodiments, the peak absorption range may be increased or decreased by 10 nm. In some embodiments, the second compound may be a dye with a maximum absorbance peak at or above 630 nm. In some other embodiments, the system may further have a third compound with the polymer substrate that includes one or more light absorbing materials, wherein the third compound absorbs green or red light.

Further in the embodiment of FIG. 5, the first absorbing compound may be impregnated into the polymer substrate. The absorbing phosphor may be solubly or insolubly dispersed throughout a diffuser. The diffuser may include at least an anti-blocking layer 506, a substrate layer 514, and a diffusing layer 502. The absorbing phosphor may be in anti-blocking layer 506, in substrate layer 514, or diffusing layer 502, and in some embodiments can be coated onto substrate layer 514, such as in coating 504. In some embodiments, the polymer substrate and the absorbing phosphor are blended with a polymer resin and extruded as a film, which is applied to the display. In other embodiments, the combination of the polymer substrate and the absorbing phosphor are produced within another layer.

The system may include an electronic device, not illustrated, that may be at least one of an LED (light-emitting diode), LCD (liquid-crystal display), computer monitor, equipment screen, television, tablet, cellular phone, gaming, smart glasses, ocular eyewear for gaming, halos, augmented reality device, virtual reality device, and extended reality device. The light improvement as disclosed herein is contemplated for at least backlight display devices.

Generally, a display system for use with electronic display devices can comprise an electronic display device and a backlight unit. The backlight unit can have a diffusing layer having a polymer substrate combined with an absorbing phosphor. The absorbing phosphor may absorb blue light between 400 and 525 nm. In some embodiments, a second absorbing compound can also be combined with the polymer substrate, the second absorbing compound absorbing in range of light comprises between 550 nm and 620 nm and the second absorbing compound absorbing about 10% more light than between 640 and 740 nm.

This disclosure also contemplates a method of converting light in a backlight unit, the method comprising providing a display system for use with electronic display devices comprising an electronic display device and a backlight unit, wherein the backlight unit comprises at least a diffuser as described herein, including the absorbing phosphor absorbing blue light. The absorbing phosphor can comprise an absorption that has a maximum absorbance peak between 400 nm and 525 nm. Diffusing layer 502, such as in FIG. 5, may further comprise a second compound with the polymer substrate, the second compound absorbing green light in a green notch, wherein the second compound can have a maximum peak re-emission of at least one of light between 530 nm and 600 nm and between 580 nm and 690 nm.

In some embodiments, the absorbing phosphor can absorb blue light from the light-emitting array in a blue notch band. The absorbing phosphor can have a maximum absorbance peak between about 400 nm and about 530 nm, wherein the absorbing phosphor can re-emit the absorbed blue light between 495-675 nm. A light conversion material can be used in combination with the absorbing materials to reduce hazardous blue light emissions below 455 nm.

In the illustration of FIG. 2, the graph may represent that the absorption with the phosphor/dye is in the range of 400-525 nm. Noting that the dye may have a broader absorption. In one embodiment, the excitation occurs between 400-470 nm and the normalized absorption coefficient is around 1, in accordance with YAG phosphor and combinations, such as YAG:Ce Phosphor. The emission can occur over a range 500-750 nm, with a margin of error of +/−20 nm.

FIG. 3 depicts colors represented in a spectral graph, showing a color gamut. FIG. 3 may include a type of gamut chart. The color emission of the color green, as illustrated in the gamut chart of FIG. 3, may be identified in a different area of the gamut charts, illustrating the change or resulting color due to the emitted light waves that are not absorbed. The triangle vertices indicate a limit of the human eye to identify color. The chart shows a display mixing a blue, green, and red dyes to get the color gamut. Because these are individual wavelengths, the emission as illustrated in the gamut chart show color areas within a narrower corner of the color emission triangle, due to narrower peaks of the emission curve (e.g. FIG. 1 and FIG. 2).

The sRGP curve of FIG. 3 is one type of graphed illustration associated with the curves of FIGS. 1 and 2. In one non-limiting embodiment, the filter may include a green dye that would have the resulting impact on the illustrated gamut of FIG. 3, making the corner associated with green light sharper. The vertices may extend out in the associated green light, extending the area of the triangle in the corner. Emission over the whole range would muddle colors. When the vertices are broadened out, even though it's brighter, the gamut chart resulting color area includes the center and the color becomes less saturated. Thus, the addition of blue phosphor into the blue wavelength absorption spectrum may reduce harmful light, but the phosphor flattens the curve in the space between the red and green curves. Therefore, each individual display having different make up formulas may have a specific amount of added green dye to sharpen the peaks of green color (wavelengths), and in some instances red color (wavelengths), to improve color sharpness of the wavelength intensity and quality.

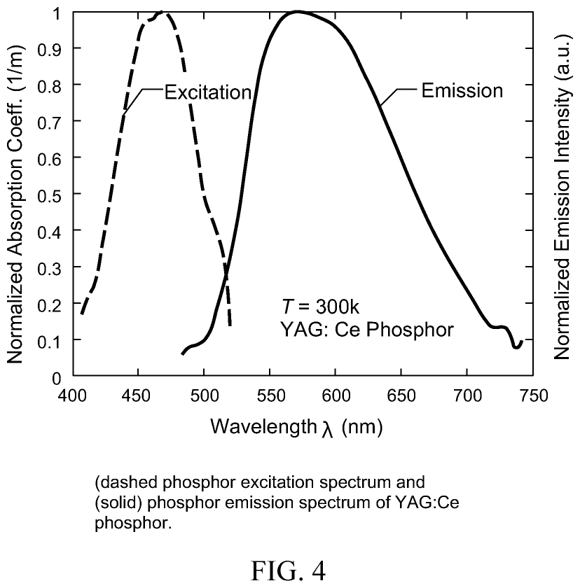

FIG. 4 may depict a broad perspective of normalized absorption coefficient per wavelength. The graph may also depict when a phosphor is added, such as YAG:Ce and the normalized emission intensity at each wavelength. FIG. 4 shows curves of normalized absorption coefficient between 400-525 nm with a coefficient max at 1. The peak above 0.5 coefficient is between 460-500 nm, with a margin of error of 20 nm. Likewise, the normalized emission curve shows a peak above 0.5 coefficient of 530 nm-660 nm, and an emission range of between 500 nm and 750 nm. Again, the emission curve has a margin of error or changed value of 20 nm. Blue absorbing phosphors or dyes may impact the absorption in a first wavelength range and re-emit light in a second wavelength range.

In other related applications referenced herein, the peaks are depicted as “dips” in the curve due to absorption. However, in FIG. 4, the peak is representative of absorption and emission.

The embodiment with YAG:Ce has been discussed, however, other phosphor and phosphor-element combinations may be used to achieve the desired reduction of blue light and green and red color sharpening. Non-limiting examples of phosphors may at least include YAG (Yttrium Aluminum Garnet, or “YAG”), Beta cylon, or oxynitrites. Others are possible to use as well as long as the filtering results are achieved and luminance is improved in strategic wavelengths. In one embodiment, KSF may be utilized and may impact the absorption spectrum. In one instance, a red phosphor (KSF, which is “K2SiF6” and/or K2SiF6:Mn) may be added, that also may absorb in the blue light associated region. However, the material, such as KSF, may impact results, and also may emit in the longer wavelengths at the red region. Thus, the addition of the Phosphor with different emission points may be implemented to tailor the display and balance different materials used in the display.

Thus, display materials may be designed for a specific display. The layers or any panels with the materials that they go into can have concentration of phosphors/dyes tailored to display specifications. In one unlimiting embodiment, a phosphor that absorbs in the blue range (shorter wavelength: 400-500 nm; 400-450 nm or 400-480 nm) more efficiently than longer wavelength may be added so a sloping absorption curve may result. Phosphor may be implemented as a primary blue light filtering mechanism, and reemission may also be impacted. Reemission may occur at another part of the spectrum, and in some embodiments is mostly centered at between 540 nm and 550 nm. The phosphors and materials also may impact luminance the most in this green region. Each phosphor may have a different advantage and cost. In one embodiment with YAG, the phosphor can be low cost compared to other material. YAG has a broad emission in the green range and into the red range.

In some embodiments, using absorbing dye between green and red wavelength ranges can further define color and can color correct by adding intensity to specific color wavelengths. The addition may help to separate green and red back into separate peaks because they will be merged together after blue phosphor re-emits. In one embodiment, green dye may absorb in the wavelength range of 575-595 nm. The formula of the dye can be modified to absorb wavelengths at lower intensity levels of light, creating more space between the peaks of the curves (also known as “valleys”). Dyes absorbing between emission peaks for red and green and may (1) absorb in blue with phosphor that emits in green or red and (2) balance/optimize color. The dye may further improve luminance by adding luminance. In other embodiments, the dye may also may provide room in the separation of green and red-light curves, such as creating lower intensity levels (or a valley) between green and red peaks. The more saturated colors become, the wider the resulting color gamut may become. Such materials to achieve these results may include, but are not limited to, blue phosphor (YAG), Green dye, other dyes, red absorbers, and blue absorbers to make definition tighter. Other emitter materials may include, but are not limited to, red phosphors that absorb blue/emit red, YAG (broad emission), and KSF (narrower emission) and these emitter materials may provide color gamut definition in area reduction or narrowness.

### Film and Film Properties

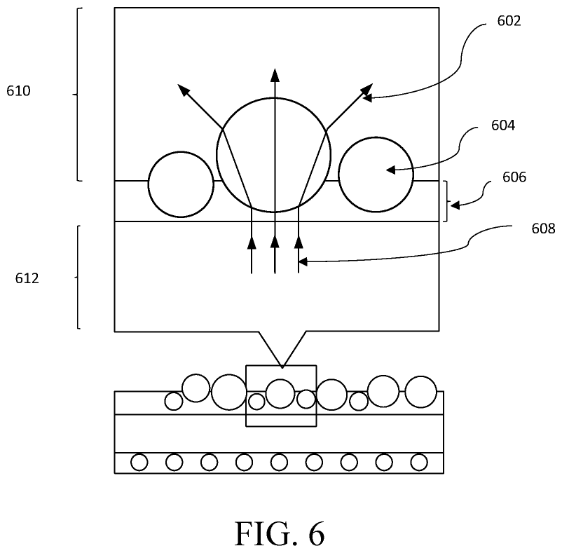

FIGS. 5 and 6 illustrate an exemplary diffuser that is useful in embodiments of the present invention to absorb specific wavelengths of light. A plurality of materials may be appropriate for the diffuser, as described in any of the embodiments included herein. A material may be chosen for a specific application based on a variety of properties. For example, a material may be chosen for a specific hardness, scratch resistance, transparency, conductivity, etc. In one embodiment, the diffuser is comprised of at least one absorbing compound and from a polymer material. Polymer material can be chosen based on the type of technology that the absorbing compounds are being applied to.

In some embodiments, a coating may be applied to the diffuser that includes fumed silica. This type of porous, expanded silica may have a single digit micron range. The material may be added to the coating to modify the viscosity/rheology of the solution. In some examples, phosphor particles can have improved suspension in the solution when the fumed silica is added to the coating. Fumed silica is an advantageous rheology/viscosity modifier, and using it as a phosphor coating may provide additional benefits such as, but not limited to, optical benefits, lower refractive index/increases transmission of film, and improving baseline transmissions.

As used herein and related referenced applications, the terms “optical density” and “absorbance” may be used interchangeably to refer to a logarithmic ratio of the amount of electromagnetic radiation incident on a material to the amount of electromagnetic radiation transmitted through the material. As used herein, “transmission” or “transmissivity” or “transmittance” may be used interchangeably to refer to the fraction or percentage of incident electromagnetic radiation at a specified wavelength that passes through a material. As used herein, “transmission curve” refers to the percent transmission of light through an optical filter as a function of wavelength. “Transmission local maximum” refers to a location on the curve (i.e. at least one point) at which the transmission of light through the optical filter is at a maximum value relative to adjacent locations on the curve. “Transmission local minimum” refers to a location on the curve at which transmission is at a minimum value relative to adjacent locations on the curve. As used herein, “50% transmission cutoff” may refer to a location on the transmission curve where the transmission of electromagnetic radiation (e.g., light) through the optical filter is about 50%.

In one embodiment, the transmission characteristics of the optical filters, for example those shown in FIG. 3, may be achieved, in one embodiment, by using a polycarbonate film as a polymer substrate, with a blue or blue-green organic dye dispersed therein. The organic dye impregnated polycarbonate film may have a thickness less than 0.3 mm. In another embodiment, the polycarbonate film may have a thickness less than 0.1 mm. The thinness of the polycarbonate film may facilitate the maximum transmission of greater than 90% of light produced by a device. In at least one embodiment, the organic dye impregnated film may have a thickness between 2.5 mils-14 mils. The combination of the polycarbonate substrate and the blue or blue-green organic dye is used in one or more embodiments of the present disclosure to provide improved heat resistant and mechanical robustness even with the reduced thickness.

In some non-limiting embodiments, others dyes and phosphors may be desired. However, to make them a compatible coating for the diffuser, fume silica (a porous expanded silica) may be included, so the small particle size (powder) may be added to the coating to modify the viscosity and rheology of the solution. Thus, phosphor particles may not sink to the bottom. The phosphor coating can be unique for coating a phosphor in addition to some optical benefits. The material can have a lower refractive index, potentially increasing the transmission of the diffuser film. In addition to the application of coating phosphors as an anti-blocking layer (506 of FIG. 5), fumed silica may coat one of the layers in the diffuser (coating 504 of FIG. 5).

Diffusers can also use fumed silica. The diffuser may include a core plastic PET film (PET film or layer 514) that is a common plastic film. The diffuser may also include a diffuser side having a coating with large particles 502 that scatter light and another side having a thinner coating that is the anti-blocking layer 506, there to keep it separate from the layers in the stack. Air may be used to create a gap (gap 510 of FIG. 5) between the light-guide plate 508 and the reflector 512. The anti-blocking layer 506 may use raised particles. Digital display technology may use dyes in an anti-blocking layer (506 of FIG. 5) instead of an extra layer in a coating, which may increase costs and complexity to the process.

FIG. 6 is an embodiment of the display film that is an expanded look at diffuser components 506, 514, 504, 502 of FIG. 5. In the illustrated diffusion film, a techpolymer 604 can be used within a layer 606, and techpolymer 604 can be an expanded view of diffusing layer (illustrated as element 502 of FIG. 5). There may be a binder layer 606 between techpolymer 604 and a PET film 612. Techpolymer(s) 604 may be located within binder layer 606 and between PET film 612 and an outer layer 610. Transmitted light 602 can be filtered out of the electronic display device of the system. More specifically, incident light 608 can filter through a binder layer 606 having techpolymer 604, and the light can be transmitted light 602 that is seen by the user of the electronic display.

Other embodiments of the film may include polycarbonate material or may include any type of optical grade polycarbonate such as, for example, LEXAN 123 R. Although polycarbonate provides desirable mechanical and optical properties for a thin film, other polymers may also be used such as a cyclic olefilm copolymer (COC).

In one embodiment, similar transmission characteristics may also be achieved, for example, by using an acrylic film with a blue-green organic dye dispersed therein. The organic dye impregnated acrylic film may have a thickness less than 0.3 mm. In another embodiment, the acrylic film may have a thickness less than 0.1 mm. The thinness of the acrylic film may facilitate the maximum transmission of greater than 90% of light produced by a device. In at least one embodiment, the organic dye impregnated film may have a thickness between 2.5 mils-14 mils. The combination of the acrylic substrate and the blue green organic dye may be used, in one or more embodiments, to provide improved heat resistant and mechanical robustness even with the reduced thickness.

In another embodiment, similar transmission characteristics may also be achieved, for example, by using an epoxy film with a blue-green organic dye dispersed therein. The organic dye impregnated epoxy film may have a thickness less than 0.1 mm. In another embodiment, the epoxy film may have a thickness less than 1 mil. The thinness of the epoxy film may facilitate the maximum transmission of greater than 90% of light produced by a device. The combination of the epoxy substrate and the blue green organic dye may be used, in one or more embodiments, to provide improved heat resistant and mechanical robustness even with the reduced thickness.

In a further embodiment, similar transmission characteristics may also be achieved, for example, by using a PVC film with a blue-green organic dye dispersed therein. The organic dye impregnated PVC film may have a thickness less than 0.1 mm. In another embodiment, the PVC film may have a thickness less than 1 mil. The thinness of the PVC film may facilitate the maximum transmission of greater than 90% of light produced by a device. The combination of the PVC substrate and the blue green organic dye may be used, in one or more embodiments, to provide improved heat resistant and mechanical robustness even with the reduced thickness.

The organic dye impregnated polycarbonate film may, in one embodiment, also have the desired optical characteristics at this reduced thickness with a parallelism of up to 25 arcseconds and a 0-30° chief ray of incident angle. In a preferred embodiment, the angle of incidence is within the range of 0-26°. The organic dye impregnated polycarbonate film may further provide improved UV absorbance with an optical density of greater than 5 in the UV range. The exemplary combination of a polycarbonate substrate with a blue-green dye is provided for example purposes only. It is to be understood that any of the absorbing compounds described in detail herein could be combined with any of the polymer substrates described herein to generate a film with the desired mechanical properties and transmissivity.

Embodiments of the optical filter, as described herein, may be used for different applications including, without limitation, as a light filter to improve color rendering and digital imaging, an LCD retardation film with superior mechanical properties, an excellent UV absorbance, a light emission reducing film for an electronic device to reduce potentially harmful wavelengths of light, and an optically correct thin laser window with high laser protection values. In these embodiments, the optical filter may be produced as a thin film with the desired optical characteristics for each of the applications.

In some embodiments, the color rendering index (CRI) change due to the disclosed invention is minimal. For example, the difference in the CRI value before and after application of the disclosed invention to an electronic device may be between one and three. Therefore, when the disclosed invention is applied to the display of an electronic device, a user viewing the display will see minimal, if any, change in color and all colors will remain visible.

While embodiments of the invention have been illustrated and described, it will also be apparent that various modifications can be made without departing from the scope of the invention. It is also contemplated that various combinations or sub combinations of the specific features and aspects of the disclosed embodiments can be combined with or substituted for one another in order to form varying modes of the invention. Accordingly, it is not intended that the invention be limited, except as by the appended claims. All references cited within are herein incorporated by reference in their entirety.

1. A light-filtering film for displays with alignment assistance comprising:
a light filtration layer;
a back sheet lining on a first side of the light filtration layer;
a cap sheet on a second side opposite the first side of the light filtration layer; and
at least one cap sheet tab on the cap sheet for aligning the light-filtering film with a computing device display.

2-5. (canceled)

6. The light-filtering film according to claim 1, wherein light filtered by the light filtration layer is high energy visible blue light having a wavelength of between about 415 nm and about 455 nm.

7. (canceled)

8. The light-filtering film according to claim 1, wherein the light filtration layer includes at least one of blue light filtering dyes or color correction dyes.

9. (canceled)

10. The light-filtering film according to claim 1, wherein the light filtration layer includes a first absorbing compound combined with a polymer substrate, the first absorbing compound absorbing blue light in a blue notch band having a full-width half maximum of not greater than about 50 nm.

11. The light-filtering film according to claim 1, wherein the light filtration layer further comprises an absorbing compound absorbing red light in a red notch.

12. (canceled)

13. The light-filtering film according to claim 1, further comprising an antiglare layer, wherein the cap sheet is adhered to the anti-glare layer.

14. The light-filtering film according to claim 1, wherein the light-filtering film has a haze level of 16-20% and a correlated color temperature loss of less than 500 Kelvin.

15-16. (canceled)

17. The light-filtering film according to claim 1, further comprising a back sheet removal tab secured along a top edge of the back sheet.

18. (canceled)

19. The light-filtering film according to claim 1, wherein the at least one cap sheet tab is comprised of two cap sheet tabs with a first cap sheet tab secured along a right edge of the cap sheet and a second cap sheet tab secured along a left edge of the cap sheet.

20. (canceled)

21. The light-filtering film according to claim 1, further comprising at least three back sheet tabs that are smaller than the at least one cap sheet tab and are located around the edge of the light-filtering film, wherein the at least one cap sheet tab and the at least three back sheet tabs are made of PET material.

22. (canceled)

23. The light-filtering film according to claim 1, wherein
the at least one cap sheet tab on the cap sheet is comprised of two cap sheet tabs;
a first of the two cap sheet tabs is located along a left edge of the cap sheet;
a second of the two cap sheet tabs is located along a right edge of the cap sheet;
the light filtering film is further comprised of at least one back sheet tab that is located on a top edge of back sheet;
a first adhesive layer is covered by the back sheet; and
a second adhesive layer is covered by the cap sheet.

24. The light-filtering film according to claim 1, further comprising:
an anti-glare layer positioned between the cap sheet and the light filtration layer; and
a base layer positioned between the light filtration layer and the back sheet.

25. The light-filtering film according to claim 24, wherein
the two cap sheet tabs and the at least one back sheet tab are each at least half clear;
the two cap sheet tabs have at least one kiss cut; and
the back sheet has a kiss cut located beneath the two cap sheet tabs.

26. A method for attaching a light-filtering film to a computing device display, comprising the steps of:
providing a light-filtering film for displays with alignment assistance, wherein the light-filtering film is comprised of a back sheet secured to a first side of an adhesive layer, a filtering layer having a bottom face secured to a second side of the adhesive layer, and a cap sheet secured to a top face of the filtering layer;
pulling on a back sheet tab to separate at least a portion of the back sheet from the adhesive layer, wherein the back sheet tab is secured to the back sheet;
aligning the light-filtering film on a computing device display by using left and right tabs that are secured to the cap sheet;
placing the aligned light-filtering film onto the computing device display;
applying pressure to adhere at least a portion of the light-filtering film to the computing device display;
removing a majority of bubbles from the adhered portion of the light-filtering film;
peeling the cap sheet off the filtering layer using the left and right tabs; and
removing the remaining bubbles.

27. The method of claim 26, wherein the filtering layer absorbs blue light in a blue notch band having a full-width half maximum of not greater than about 50 nm and wherein absorption is in the wavelength range of 415 nm to 465 nm.

28. The method of claim 26, wherein placement of the aligned light-filtering film onto the computing device display takes place until the adhesive layer begins to wet out and at least a portion of the adhesive layer adheres to the display.

29. The method of claim 26, wherein pressure can be applies using a squeegee.

30. The method of claim 26, further comprising removing a back sheet from the left and right tabs to expose an adhesive layer on the left and right tabs.

31. The method of claim 30, further comprising wrapping the left and right tabs around the computing device display and adhering the left and right tabs to the computing device display.

32. The method of claim 26, further comprising separating a remaining portion of the back sheet from the adhesive layer by pulling on a second back sheet tab.
